(19) United States
(12) Patent Application Publication
(10) Pub. No.: US 2004/0244248 A1
(43) Pub. Date: Dec. 9, 2004

(54) Flag mag

(76) Inventor: G.C. Harned, Carrollton, TX (US)

Correspondence Address: G.C. HARNED, PMB 114 - 173, 4009 - OLD DENTON RD, CARROLLTON, TX, 75007, US

(21) Appl. No.: 10/456,157

(22) Filed: Jun. 9, 2003

(51) Int. Cl. G09F 21/04; G09F 7/04

(52) U.S. Cl. 40/600; 40/591

(57) ABSTRACT

The Flag Mag is a magnetic based flag holder. The heavy duty magnetic base will adhere to any metal surface without damage. The staff then displays any flag, sign, logo, etc. Use is for any vehicle, truck, file cab, etc. wanting to display team flags, corporate logo, school, or national flag. The current flag display for vehicles is window mount; the Flag Mag is deck, hood, top, etc. mount.

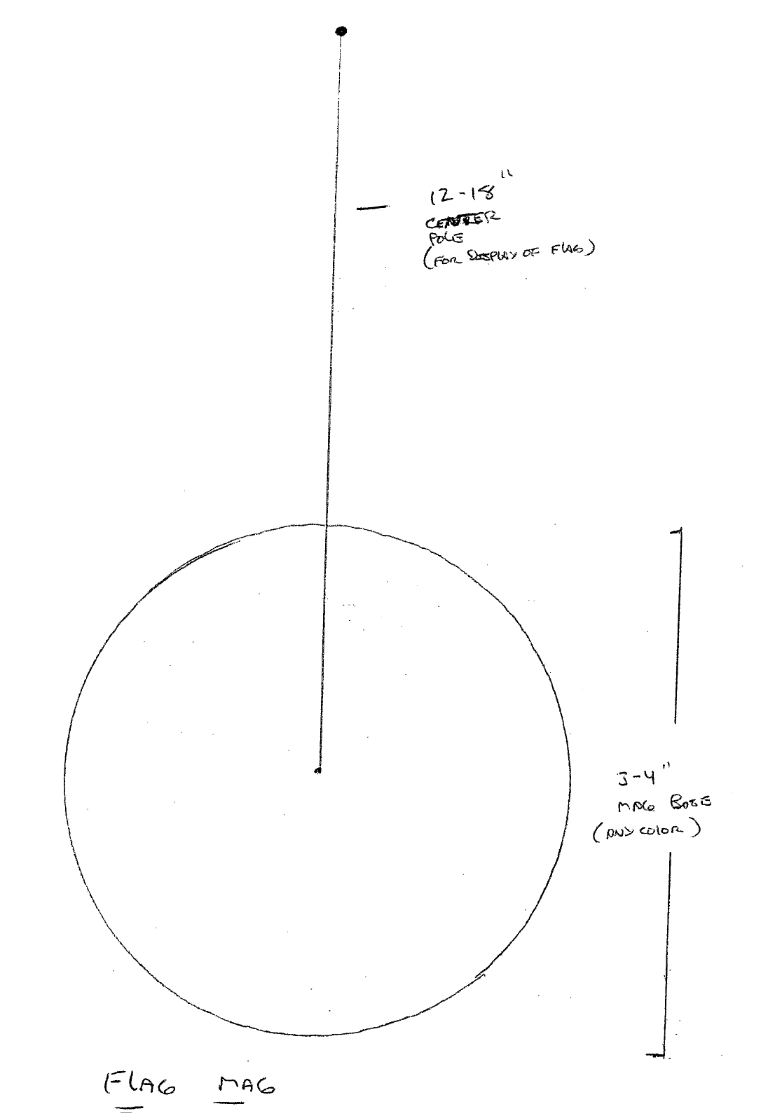

Magnetic disc w 12-18 inch metal or plastic rod attached. To be used to mount on any metal object and display flag or banner etc. Car, truck, file cab, etc.

School flag, American flag, Team flag, Fund raising items, Work logo, more. . . . . . .

1. (cancel)

2. The Flag Mag allows mounting for all metal objects to have a stable base attached flag holder with no damage to the surface, no blocking of windows, no need to hang an item on a door or window; many vehicles do not have the ability to roll down the window chosen to hang a flag, ie. a van, the flag mag can be attached to the roof of the vehicle allowing any vehicle made of metal to be able to fly a team, state, or national flag as well as an advertising banner or other business logo without needing to do costly conversion or damaging the surface; the flag mag can also be used outdoors at trade shows, festivals, booths, etc to provide a stable signage post or indoors in offices and businesses without the need for costly modifications only needing a metal mounting surface; the flag mag also allows for ease of movement from item to item or from flag/banner/sign to another without damage to surface.
